(19) United States
(12) Patent Application Publication
(10) Pub. No.: US 2008/0109849 A1
(43) Pub. Date: May 8, 2008

(54) Viewer Profiles for Configuring Set Top Terminals

(76) Inventor: Yeqing Wang, Horsham, PA (US)

Correspondence Address: Motorola, Inc.;Law Department, 1303 East Algonquin Road, 3rd Floor, Schaumburg, IL, 60196, US

(21) Appl. No.: 11/557,156

(22) Filed: Nov. 7, 2006

(51) Int. Cl. G06F 3/00

(52) U.S. Cl. 725/46

(57) ABSTRACT

A set top terminal is provided that includes a receiver/tuner for receiving programming content over a broadband communications network and a decoder for decoding the programming content provided by the receiver/tuner. The set top terminal also includes a database capable of storing a plurality of viewer profiles each containing at least one viewer preference associated with a registered viewer. The viewer preference reflects a programming or user configuration preference of the registered viewer. A processor is operationally associated with the receiver/tuner, the decoder, and the database and a user interface operationally associated with the processor. The processor is configured to operate in accordance with each of the viewer profiles.

### FIELD OF THE INVENTION

The present invention relates generally to set top terminals, and more particularly to set top terminals that contain multiple viewer profiles that reflect programming or user configuration preferences of the viewer and which are automatically implemented by the set top terminals and communicated and shared by set top terminals within the same household over a home network.

### BACKGROUND OF THE INVENTION

A conventional system for displaying a program, e.g., a video program, includes a monitor or a television (TV) set connected to a set top box or terminal. The set top box is connected through a coaxial cable to a cable TV network or a satellite dish for “satellite TV.” The TV set and the set top box are located, for example, in a user's home and receive a multitude of TV channels from a broadcast head end, wherein each TV channel presents a multitude of programs during a typical day. In order to select and watch a certain program, the user controls the set top box to tune to a desired channel. The TV set receives a video signal from the set top box and displays the program of the desired channel.

As set top terminals continue to advance, they have become more feature-rich, providing a wide array of options for the viewer. For instance, many set top terminals include digital video recorder (DVR) capabilities to record and store video programs received from the coaxial cable, satellite dish, and the like. This feature allows viewers to schedule programs to be recorded for play back at a later time, record what users are watching in real-time to allow them, for instance, to pause a real-time program when, for example, the viewer must leave the room. Viewers may resume their viewing where they left off, and may fast forward through commercials until they reach the point at which the program is currently being provided. While the provision of DVR capabilities has many advantages for the viewer, it unfortunately may also increase the complexity of the set top terminal for viewers.

Another feature that is often incorporated into set top terminals to enhance a television viewer's experience is an Electronic Program Guide (EPG). As known in the art, the electronic program guide lists scheduled programs for a predetermined period of time (e.g., two weeks) and provides, among other things, information about broadcast dates and times and content information. Although set-top terminals equipped with an EPG enable users to identify and locate programming of interest to them, it has become more and more difficult and time-consuming to use as the number of channels and diversity of available programming continues to increase.

Set top terminals generally offer simple viewer programming capabilities to enhance their convenience. For example, programming can be used to record a show in advance, to maintain a selection of favorite shows or channels to thereby avoid the need to search the entire EPG, or to specify the actions of certain keys on a remote control or other user input device. While such programming and customization may be helpful for a single viewer, it can become problematic when multiple viewers use the same set top terminal. For instance, different viewers may want to record different shows to configure keys in a different manner. Likewise, different viewers may have favorite shows and/or channels that differ from one another. Thus, despite the incorporation of such programming capabilities, the flexibility of set top terminals to accommodate the various preferences of different viewers is limited.

### BRIEF DESCRIPTION OF THE DRAWINGS

FIG. 1 shows a functional block diagram of a digital set-top terminal.

FIG. 2 illustrates one example of a viewer profile database containing viewer programming profiles for multiple viewers.

FIG. 3 is a flowchart illustrating an example of how a viewer may set up and use a viewer profile.

### DETAILED DESCRIPTION

As set top terminals increase in sophistication, they continue to offer more and more features and options for controlling how and when viewers view the content received by the terminals. For instance, current digital broadcasting systems may include two hundred or more channels that are available to viewers. In this regard, it is impractical to scan all the available channels to search for a desired broadcast program. While an EPG helps viewers to more quickly and efficiently search for a desired program, with so many available channels, even searching through the entire EPG can be arduous. In addition, the viewer is often faced with a myriad of other options that each require a decision on the part of the viewer, followed by one or more steps that must be performed to implement each decision. For instance, the viewer may need to decide whether to watch a program when it is broadcast or record it for later viewing. Yet another option that is often presented to the viewer is whether or not to access premium programming or pay-per-view events that incur additional charges. Accordingly, it would be helpful if individual viewers could be presented with a more tailored selection of programming and options that best conforms to the viewer's preferences so that, for instance, the viewer does not need to search the entire EPG to find programming he or she may be interested in. While in principle it may be possible to customize various viewer options for a given individual, the situation becomes significantly more complex if multiple viewers use the same set top terminal since different viewers will generally have different preferences. For instance, one particular viewer may be interested in various sports and movie channels while another viewer may be interested in channels that provide topical programming such as documentaries and news.

In the system and methods described herein, the set top terminal can be controlled by individual viewer profiles stored in a viewer profile database. The profiles of different viewers may be in operation at different times of a given day or week. In this way, when a particular viewer profile is operational at the pre-selected times, the set top terminal is automatically configured or customized to the viewing habits of the particular viewer (or category of viewers such as parents or children) associated with the profile. For instance, at the appropriate time, the set top terminal can present the viewer with a personalized EPG that only includes his or her personal channels. Alternatively, or in addition thereto, the viewer may be presented with a list of favorite shows (in some cases the favorite shows may be highlighted in the personalized EPG). At these times the set top terminal can also be directed to record one of the favorite shows and/or tune to one of the favorite channels so that when the viewer activates the display it is immediately available.

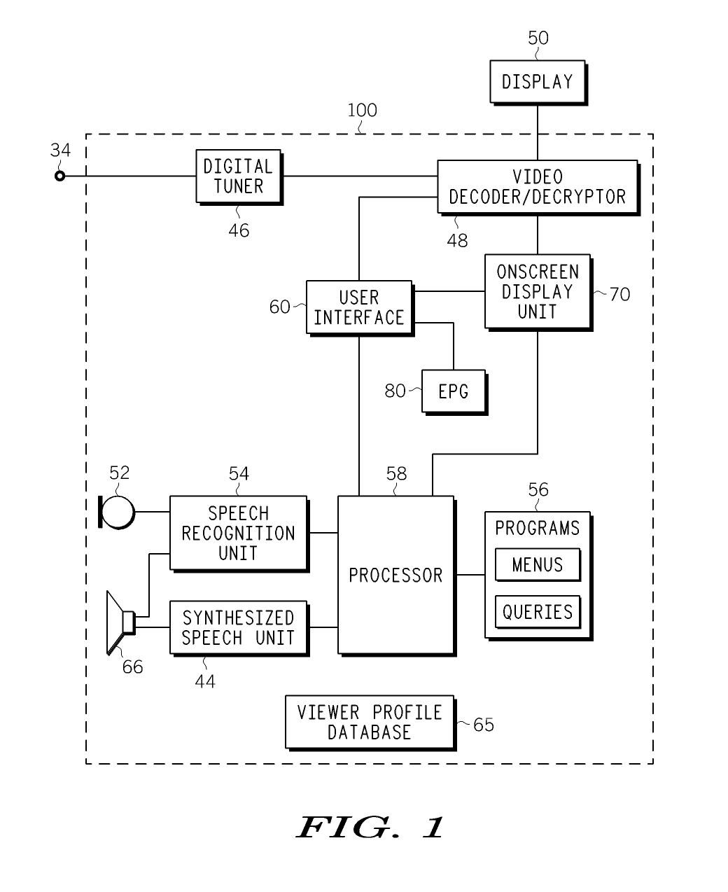

FIG. 1 shows one example of a digital set-top terminal 100. These units offer digital video, audio, and high speed-data services along with streaming media, PPV, Internet services, HDTV, and personal video recorder (PVR) capabilities. Of course, digital set top 100 terminal is only one example of a set top terminal and is presented by way of illustration only.

Digital set-top terminal 100 includes a digital tuner 46 for tuning to a desired digital television channel from the band of television signals received by the set-top 100 via input 34. Decryption and decompression hardware and associated software are included in the video decoder/decrypter 48 for decoding the tuned digital signal (e.g. an MPEG-2 television signal) prior to sending it to the display 50. The decoder/decrypter 48 may also include decryption circuitry that decrypts an encrypted content from the content feed. Some broadcasts, particularly pay-per-view broadcasts or premium channels such as HBO™ and Showtime™ are encrypted so that non-subscribers cannot view the content. The decrypter 48 decrypts any such encrypted content for viewing on the display unit 50 by the consumer. The decrypter may include a variety of decryption schemes for corresponding premium channels or services. As with conventional cable boxes, the decryption circuitry may be enabled or disabled depending upon the consumer's subscription to the premium channel or associated encrypted content. Authorization for decryption may be governed by appropriate payment for the associated content. For example, pay-per-view content is typically encrypted with decryption authorization governed by an appropriate one-time payment by the consumer.

While not shown in FIG. 1, it will be recognized that the digital set-top terminal 100 will generally also include an analog tuner to decode and display analog video.

An electronic program guide (EPG) 80 is also provided in set-top terminal 100. The EPG 80 is an interactive, on-screen display feature that displays information analogous to TV listings found in local newspapers or other print media. The EPG, which is generally received along with the programming content, may be updated on a periodic basis so that the consumer can make appropriate selection for upcoming programs. The electronic program guide 80 displays information on the display unit 50 using onscreen display processor 70, which is also used for displaying additional information such as control menus and the like. In some cases, instead of transmitting it along with the programming, the electronic program guide 80 may be downloaded via a telephone line, cable connection, satellite up-link, or radio broadcast antenna.

The digital set-top terminal 100 also includes a user interface 60. The user interface 60 may include various control devices such as a keypad connected directly to the set top box 100 or a remote control device connected by an infrared link. The user interface 60 permits the user to interact with the set top box 100 and electronic program guide 80 to thereby select content for recording and on-demand playback. Also, as detailed below, the user interface 60 may be employed to create individual viewer profiles that customize the set top terminal for each viewer or category of viewer.

As an adjunct to the user interface 60, some set top terminals may also receive user commands and other instructions by voice input. In such a case the set top terminal 100 also includes a microphone 52 that is operative to detect a speech signal. Microphone 52 converts the speech signal to an electric signal as is well known in the art. The electric signal is provided to a speech recognition unit 54, also referred to as a voice recognition unit. Hereinafter, the terms “speech recognition” and “voice recognition” are interchangeably used. Speech recognition unit 54 may include conventional interface circuitry for operating a speaker 66, which may be employed to provide voice messages to the user. The voice messages may be accompanied by messages displayed on display unit 50. In some cases the set top terminal 100 may not include its own dedicated speaker, but may simply employ the speaker associated with the display unit 50.

The viewer may use the user interface or speech recognition engine to browse through the program guide, operate features in the program guide, refer to data presented on on-screen menus, retrieve selected program guide data, record programs, make selections and configure the program guide. The viewer may also establish his or her own individual profile, as discussed in more detail below. All these operations may be performed either in a conventional mode of operation by pressing keys on a keyboard or remote control associated with user interface 60, or in a voice activated mode of operation by entering voice commands and instructions and by making voice selections with the use of the speaker 66 and speech recognition unit 54. Additionally, these operations may be done while the viewer is viewing programming on display unit 50.

The aforementioned components of set-top terminal 100 may all operate under the control of a processor 58. The on-screen display unit 70, under the control of the EPG 80, the processor 58, the user interface 60, or the speech recognition unit may generate messages and graphic information which are converted by display unit 70 to a format suitable for display on display unit 50, which may be, for example, a conventional television display. The messages may include menus, error messages, control messages and the viewer profiles discussed below.

It should be noted that the processor 58, digital tuner 46, video decoder 48, user interface processor 60, onscreen display processor 70, speech recognition unit 54 and the other components shown in FIG. 1 may each be implemented in hardware, software or a combination thereof. In addition, although the various components are shown as separate processors, it is contemplated that they may be combined and implemented as separate processes on one or more processors.

Set top terminal 100 also includes a viewer profile database 65 that may be used to store information for each registered viewer concerning their respective programming and/or configuration preferences. The information associated with each registered user is maintained in plural records. Each record may comprise, for instance, a list of favorite channels, favorite shows, daily or weekly selections, settings, restrictions and/or other viewer preferences. When retrieved, the list of favorite channels or shows may be presented to the user on the display unit 50, possibly in the format of an abbreviated EPG. The viewer profile may also instruct the set top terminal to simply display and/or record a particular show or channel. In addition, when a given viewer profile is in operation, it may also automatically configure the set top terminal in accordance with other personal preferences of the viewer such as those involving the user interface, menus and the like.

The viewer profiles described herein permit multiple viewers in the same residence or household to conveniently use a common set top terminal in a manner that is tailored to their individual preferences. Moreover, since the profile of a given viewer is only active when the viewer is likely to be viewing programming using the set top terminal, different profiles do not conflict with one another. In some cases a viewer may be able to invoke or otherwise activate his or her profile at times other than those prescribed in the profile, thereby adding an additional degree of flexibility and convenience for the viewer.

The viewer profiles allow household members to tailor the set top terminal around their own viewing habits. For instance, if in a household with children the children are permitted to watch television between 5 pm and 6 pm on weeknights and 8 am to 10 am on weekend mornings, the set top terminal may provide them access to their favorite channels and/or shows and may also prevent them from viewing any other channels during these time periods. Similarly, the set top terminal may be configured in accordance with a parental profile between say, the hours of 7 pm and 11 pm on weeknights. During these hours the set top terminal may provide access to the parents' favorite channels and/or shows. In this way the viewer can quickly find a show or channel of interest without being required to navigate through a complicated menu of perhaps hundreds of channels.

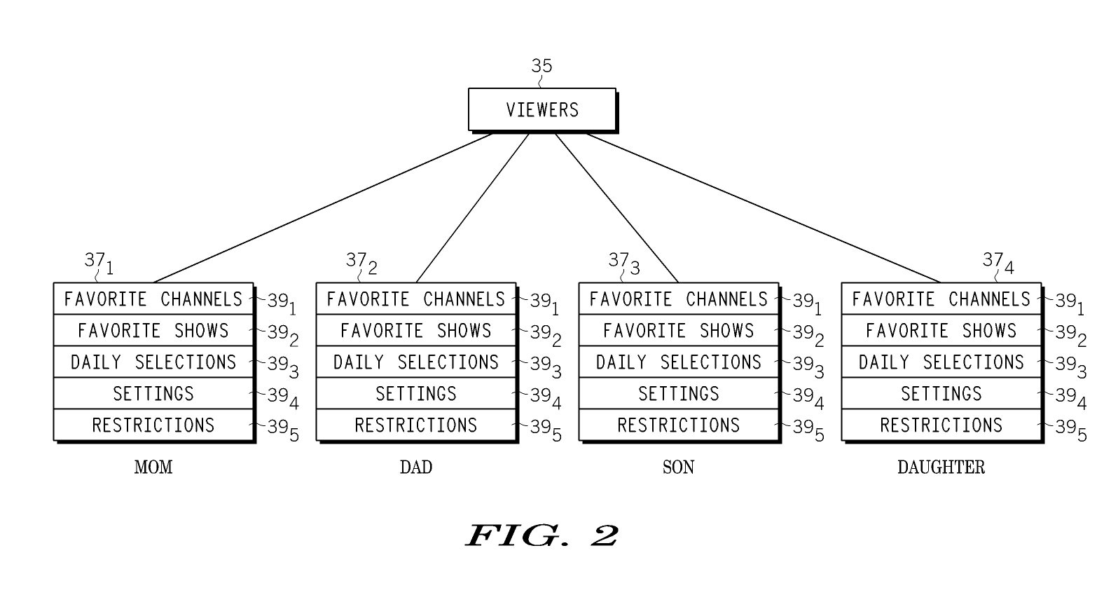

FIG. 2 shows an illustrative representation of the viewer profile database 65 indicating how the information may be structured and linked together. While the database 65 is shown having a tree structure, any other appropriate arrangement may be employed to link together the data stored in database 65. The database includes a main folder of viewers 35, each of whom in turn have their own profile folder. For instance, in FIG. 2, the profile folders 37₁-37₄ are shown for a family of four and include a folder for mom (folder 37₁), dad (folder 37₂), son (folder 37₃), and daughter (folder 37₄). Each of the folders 37 is linked to a series of records 39 in which profile information associated with each user is stored. For example, in FIG. 2, illustrative viewer records include records for favorite channels 39₁, favorite shows 39₂, daily selections (to view select programming only on one or more particular days of the week) 39₃, settings (for customizing the user interface and the like) 39₄, and restrictions 39₅. Of course, the profile folders may include different or additional records than those that are presented herein for purposes of illustration only. Moreover, the viewer profile database may be formatted in a wide variety of different configurations and is not limited to the particular configuration shown in FIG. 2.

The viewer profile folders 37₁-37₄ may or may not include all the same record fields. For instance, it generally will not be necessary for the parental folders to include the restrictions record. Alternatively, the restrictions record may be present in the mom and dad folders, but they may simply remain unpopulated. On the other hand, the parental folders may include an override command that allows them to view other programming that does not conform to their respective profiles, whereas the children's folders may have no such feature.

A residence often has more than one television, each of which requires their own set top terminal. For instance, televisions are often located in living rooms, bedrooms and kitchens. More and more such set top terminals are being networked together so that they can communicate with one another and share information so that, for instance, a program recorded by the DVR in one set top terminal can be played on a television associated with another set top terminal.

Set top terminals located in a single residence or building may communicate with one another over a LAN that operates in accordance with any of a variety of different communication standards such as Ethernet, Powerline Communication (PCL) networks, MoCA (Multimedia over Coax Alliance) and certain wireless mechanism (e.g., 802.11, Bluetooth), which allow connectivity between different networked devices such as televisions, media centers, set top terminals, digital video recorders, stereos, computers, and appliances. The standards may be implemented in a wireless or wired manner using, for example, already installed coax cable.

The viewer profiles described herein may be used to coordinate the use of such networked set top terminals. In particular, viewer profiles may be configured so that they are not only operational at certain days and times, but also on one or more selected set top terminals that are networked together. For instance, returning to FIG. 2, the records 39 in each profile folder 37 may have a field to specify the particular set top terminal or terminals on which the respective record is to be operational. For example, returning to the previous example of a household with parents and two children, a second television and set top terminal may reside in a den or family room in which, say, mom may want to watch television on weekdays between 8 to 9 pm and dad wants to watch television in the kitchen from 5:30 to 7 pm. In this case mom may designate that one or more records in her viewer profile should be operative in the den from 8 to 9 pm while dad may designate that one or more records in his viewer profile should be operative in the kitchen from 5:30 to 7 pm.

The viewer profiles may be established or modified via the user interface or speech recognition unit associated with any of the set top terminals. The profiles may then be communicated over the network so that they are available to all the networked set top boxes. In this way any set top terminal may be used to establish viewer profiles that are to be implemented on any of the other networked set top terminals.

The processes described above in connection with the set-top terminal 100 may be implemented in general, multi-purpose or single purpose processors respectively associated with the set-top terminal 100. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

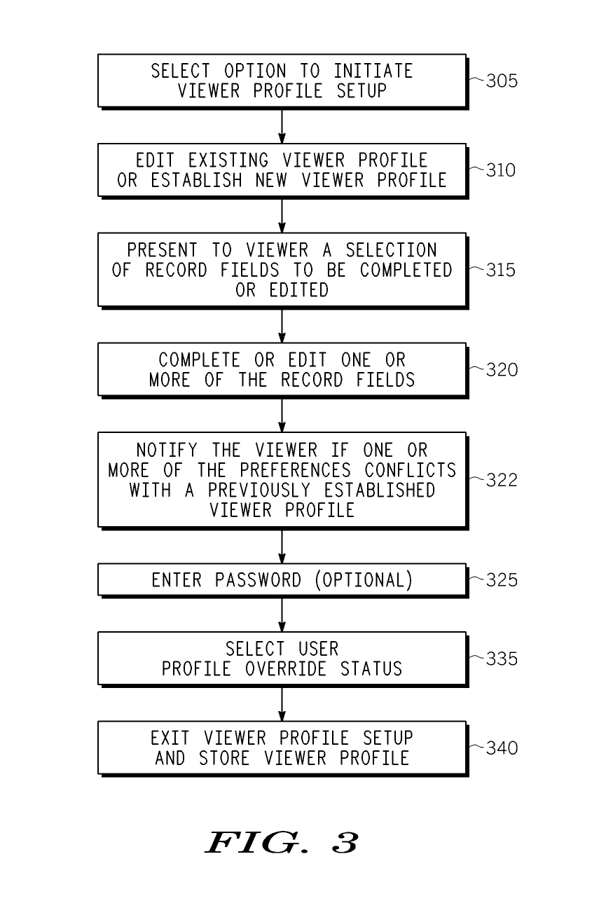

FIG. 3 shows one example of how a viewer may create and use a viewer profile. The process begins in step 305 when the viewer provides an input (e.g., via a keyboard entry, voice command, a point and select command, or a combination thereof) to the set top terminal to initiate a viewer profile setup procedure. Once the setup procedure has begun, subsequent actions of the viewer in some cases may be performed in response to menu prompts that are displayed visually on the display device, in response to spoken prompts, or the like. Next, in step 310 a query is presented asking the viewer whether he or she wishes to edit an existing profile or establish a new viewer profile. Assuming the viewer wants to establish a new viewer profile, the viewer is presented in step 315 with a series of fields that are to be completed by entering text, selecting items from a pull-down menu, or by any other appropriate means. As previously mentioned, such fields may include record fields for favorite channels, favorite shows, daily selections, setting, restrictions, and the like. The viewer completes some or all of the fields in step 320. In the event that the viewer selects or enters an item that conflicts with a pre-existing viewer profile (e.g., the viewer attempts to view a program at the same time another profile specifies that a program is to be viewed), a message noting the conflict will be presented to the viewer in step 322. If the pre-existing view profile can be overridden, the viewer will be given an opportunity to do so. If it cannot be overridden, the viewer will be requested to make a different selection. In step 325 a query is presented asking the viewer if the profile is to be password protected. If so, a password is entered in step 325. A password may be appropriate, for instance, if the profile is being set up by a parent on behalf of a child, or when a viewer is concerned that someone intentionally or inadvertently may alter the profile without the viewer's knowledge. In step 335 a query is presented to the viewer asking if the viewer profile (or selected preferences included in the viewer profile) may be overridden. While an override command may be convenient and offer the viewer enhanced flexibility, it once again may not be appropriate if the profile is being set up by a parent on behalf of a child. Finally, in step 340 the viewer saves the profile settings and exits the viewer profile setup.

1. A set top terminal comprising:
a receiver/tuner for receiving programming content over a broadband communications network;
a decoder for decoding the programming content provided by the receiver/tuner;
a database capable of storing a plurality of viewer profiles each containing at least one viewer preference associated with a registered viewer, said viewer preference reflecting a programming or user configuration preference of the registered viewer;
a processor operationally associated with the receiver/tuner, the decoder, and the database;
a user interface operationally associated with the processor; and
wherein the processor is configured to operate in accordance with each of the viewer profiles.

2. The set top terminal of claim 1 further comprising a second database for storing an EPG, wherein at least one of the viewer preferences is a program selected from the EPG.

3. The set top terminal of claim 1 wherein each of said viewer preferences designates a particular circumstance under or a time at which it is to be operational.

4. The set top terminal of claim 1 wherein particular circumstances under which at least one of the viewer preferences is operational is defined by a broadcast time of a favorite program.

5. The set top terminal of claim 1 further comprising a network interface for receiving at least one additional viewer profile over a local area network and wherein the processor is further configured to operate in accordance with the at least one additional profile.

6. The set top terminal of claim 1 further comprising an on-screen display unit for displaying information associated with the viewer profiles.

7. The set top terminal of claim 1 wherein the user interface comprises a keypad.

8. The set top terminal of claim 1 wherein at least one of the viewer profiles includes a record of a viewer preference having a plurality of fields including a field specifying an identifier of a networked set top terminal on which the record is to be implemented.

9. At least one computer-readable medium encoded with instructions which, when executed by a processor, performs a method including:
receiving a viewer profile from each of a plurality of viewers, each of said viewer profiles including at least one viewer preference reflecting a programming or user configuration preference of the respective viewer;
storing the plurality of viewer profiles; and
configuring a set top terminal to operate in accordance with each of the viewer preferences.

10. The computer-readable medium of claim 9 wherein each of said viewer preferences designates a particular circumstance under or a time at which it is to be operational.

11. The computer-readable medium of claim 9 wherein the viewer profile includes a least one viewer preference specifying at least one favorite channel or favorite program.

12. The computer-readable medium of claim 9 wherein the viewer profile includes a viewer preference specifying at least one particular networked set top terminal on which the viewer profile is to be implemented.

13. The computer-readable medium of claim 9 wherein the viewer profile is received by a first set top terminal and configures a second set top terminal networked to the first set top terminal.

14. The computer-readable medium of claim 9 wherein said viewer preference specifies whether the set top terminal is to be configured to display and/or record a particular program.

15. The computer-readable medium of claim 9 wherein the at least one viewer preference associated with the registered viewer is received from the viewer in response to a query.

16. The computer-readable medium of claim 15 wherein the query is presented to the viewer at least in part as a pull-down menu of options on a display device.

17. At least one computer-readable medium encoded with instructions which, when executed by a processor, performs a method including:
identifying a particular viewer profile from among a plurality of viewer profiles that are each associated with a viewer registered with a set top terminal;
retrieving from a database at least one viewer preference associated with the particular viewer profile, said viewer preference reflecting a programming or user configuration preference of the viewer and designating a particular circumstance under or a time at which it is to be operational; and
configuring the set top terminal to operate in accordance with the viewer profile at the particular time or under the particular circumstance specified therein.

18. The computer-readable medium of claim 17 wherein the viewer profile includes a least one viewer preference specifying at least one favorite channel or favorite program.

19. The computer-readable medium of claim 17 wherein the viewer profile includes a viewer preference specifying at least one particular networked set top terminal on which the viewer profile is to be implemented.

20. The computer-readable medium of claim 17 wherein the viewer profile is received by a first set top terminal and configures a second set top terminal networked to the first set top terminal.
